(19) United States
(12) Patent Application Publication
(10) Pub. No.: US 2016/0066163 A1
(43) Pub. Date: Mar. 3, 2016

(54) METHOD AND APPARATUS FOR MULTIPLE TYPES OF GROUP MEMBERSHIP BASED ON STATUS IN APPLICATIONS

(71) Applicant: MOTOROLA SOLUTIONS, INC, SCHAUMBURG, IL (US)

(72) Inventors: ANATOLY AGULNIK, DEERFIELD, IL (US); LIN LIN, FOX RIVER GROVE, IL (US); JAMES E. MATHIS, BARRINGTON, IL (US)

(21) Appl. No.: 14/471,768

(22) Filed: Aug. 28, 2014

(51) Int. Cl. H04W 4/08; H04W 76/00; H04W 4/10; H04W 4/22; H04W 4/02

(52) U.S. Cl. CPC H04W 4/08; H04W 4/22; H04W 4/02; H04W 4/10; H04W 76/005

(57) ABSTRACT

A method of supporting multiple types of group membership in a group based on group-member-status as a member of a group in a set of applications includes tracking a group-member-status as a member of the group in a first application of the set of applications for each group member, wherein the first application is operated with mobile devices of some or all of the group members and the mobile devices communicate on a network, and wherein the group-member-status is based on a group member's relationship with the group in the first application; receiving a request for a list of the group members with a particular group-member-status as a member of the group in the first application, wherein the request is from a second application of the set of applications; and providing a list of the group members with the particular group-member-status in the first application to the second application.

### BACKGROUND OF THE INVENTION

Next generation public safety (NGPS) networks are being deployed to offer public safety personnel (also referred to as responders) rich application support in mission-critical applications. In conventional public safety networks such as LMR, DMR, etc., various responders can be assigned to different talkgroups. This was sufficient as the sole application on these networks was voice communication, and talkgroup membership lists sufficed. The NGPS networks include broadband (BB) networks such as Long Term Evolution (LTE), and mobile devices can support a variety of different applications for the responders. As such, single talkgroup membership lists no longer suffice for the variety of different applications. Specifically, there is a need to dynamically manage group membership in the NGPS networks.

Accordingly, there is a need for a method and apparatus for multiple types of group membership based on the members' status in the group in each of multiple applications.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a network diagram of a network, such as a NGPS network, with a plurality of mobile devices in accordance with some embodiments.

FIG. 2 is a flow diagram of the functionality of the shared group manager server in the network of FIG. 1 in accordance with some embodiments.

FIG. 3 is a network diagram of an exemplary network infrastructure with the shared group manager server in the network of FIG. 1 in accordance with some embodiments.

FIG. 4 is a block diagram of a server for implementing the shared group manager server in the network of FIG. 1 in accordance with some embodiments.

FIG. 5 is a block diagram of a mobile device of the network of FIG. 1 in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

In an exemplary embodiment, a method of supporting multiple types of group membership in a group based on group-member-status as a member of a group in a set of applications includes tracking a group-member-status as a member of the group in a first application of the set of applications for each group member, wherein the first application is operated with mobile devices of some or all of the group members and the mobile devices communicate on a network, and wherein the group-member-status is based on the group member relationship with the group in the first application; receiving a request for the list of the group members with a particular group-member-status as a member of the group in the first application, wherein the request is from a second application of the set of applications; and providing a list of the group members with the particular group-member-status in the first application to the second application.

In another exemplary embodiment, a shared group manager server supporting multiple types of group membership in a group based on group-member-status as a member of a group in a set of applications includes a network interface communicatively coupled to a network; a processor communicatively coupled to the network interface; and memory storing computer executable instructions, and in response to execution by the processor, the computer executable instructions cause the processor to perform steps of: track a group-member-status as a member of the group in a first application of the set of applications for each group member, wherein the first application is operated with mobile devices of some or all of the group members and the mobile devices communicate on the network, and wherein the group-member-status is based on the group member relationship with the group in the first application; receive a request for the list of the group members with a particular status as a member of the group in the first application, wherein the request is from a second application of the set of applications; and provide a list of the group members with the particular group-member-status in the first application to the second application.

In a further exemplary embodiment, a network includes a plurality of mobile devices communicatively coupled to one another wirelessly and each operating a plurality of applications; and a shared group manager server communicatively coupled to the plurality of mobile devices, wherein the shared group manager comprises memory storing computer executable instructions, and in response to execution by a processor, the computer executable instructions cause the processor to: track a group-member-status as a member of a group in a first application of the plurality of applications for each group member, wherein the group-member-status is based on the group member relationship with the group in the first application; receive a request for the group-member-status of the group members in the first application identifying the group members with a particular group-member-status, wherein the request is from a second application of the plurality of applications; and provide a list of the group members with the particular group-member-status in the first application to the second application.

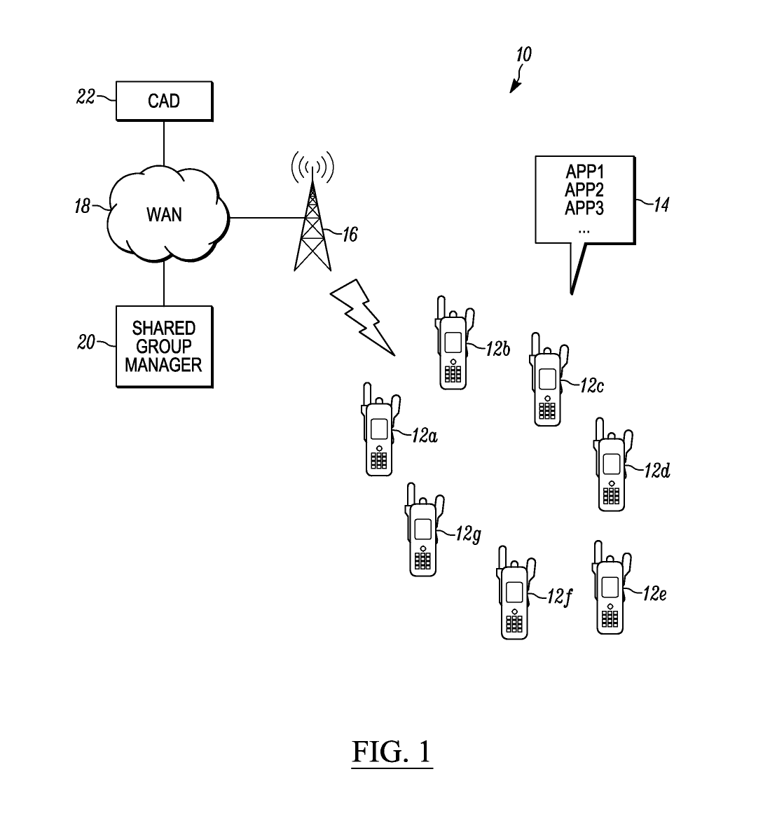

FIG. 1 is a network diagram of a network 10, such as a NGPS network, with a plurality of mobile devices 12 (depicted as mobile devices 12a-12g). Each of the plurality of mobile devices 12 is configured to operate one or more applications (“apps”) 14 (depicted as app1, app2, app3, . . . ). The apps 14 can include anything utilized by the responders associated with the mobile devices 12 such as, for example, video services, web services, push-to-talk services, location services, command-and-control services, dispatch services, etc. The network 10 includes one or more base stations 16 such as evolved Node Bs (eNBs) that wirelessly communicate with the mobile devices 12. The base stations 16 are communicatively coupled to a wide area network (WAN) 18 which can be a combination of wired and wireless networks. In an exemplary embodiment, the base stations 16 can utilize LTE to communicate with the mobile devices 12. However, any type of broadband communication is contemplated.

The network 10 includes a shared group manager server 20 communicatively coupled to the mobile devices 12, such as through the WAN 18 and the base stations 16. Also, the network 10 can include a computer-aided dispatch (CAD) 22 for managing an incident scene. Variously, the shared group manager server 20 is configured to dynamically manage group membership based on responders' group-member-status as the group members in the applications 14. That is, the shared group manager server 20 provides dynamic membership in groups for broadband services across the different apps 14 extending beyond a single talkgroup list. The shared group manager server 20 enables dynamic management of group membership such as providing the apps 14 with a different subset of members of a same group depending on a ‘state,’ or a ‘group-member-status,’ of the members in the group in selected apps 14. For example, one of the applications 14 may be an application that dynamically sends a picture, video, or audio to all members of a group that are active in another application 14, such as are currently participating in a PTT group call, for the group. That is, the picture, video, or audio is not simply sent to all group members, but only the group members on the PTT group call—these group members on the PTT group call form a dynamic subset of the group.

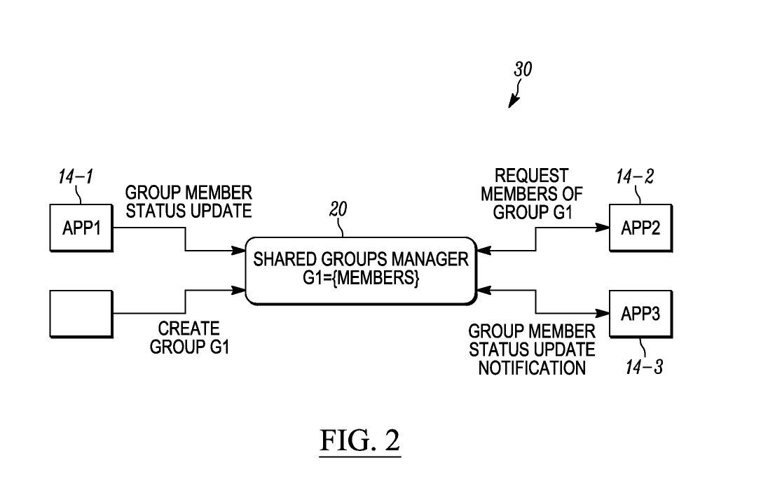

FIG. 2 is a flow diagram of a functional flow 30 illustrating an operation of the shared group manager server 20 in the network 10. Note, the shared group manager server 20 is communicatively coupled to the mobile devices 12 and optionally to the CAD 22 (as shown in FIG. 1). First, in the functional flow 30, a group (G1) is created. The group G1 includes a plurality of group members (i.e., users of the mobile devices 12). For example, a first application, app1 14-1 (e.g., CAD 22), can create the group G1 and define the group members, i.e., G1={members}, at the shared group manager server 20.

Next, another application, e.g., the app2 14-2, queries the shared group manager server 20 for a list of the group members in order to provide a particular service to them. For example, suppose the CAD 22 creates an incident and dispatches responders to the incident. Further, suppose an incident commander wants to send a link to a video from a camera at the incident scene to all dispatched responders, or wants to initiate a PTT call with all dispatched responders. The app2, for example, a Real-Time Video Intelligence (RTVI) application or a PTT application, then needs to determine the group members at the incident scene to whom to distribute the link.

That is, for some applications, responders have to join a group application (via their mobile device 12) using application-specific procedures in order for the responder to become a participant in the group application, for example, in an incident group conversation. Thus, this requires active participation, and if some of the responders assigned to the incident join the application, i.e., the incident group conversation, and some of the responders do not, then only the responders that join the group in the particular application can participate in the group communications provided by such an application. Further, suppose that the incident commander then wants to discuss an image, clip, video, etc. with the responders that are currently participating in the application, i.e., the incident group conversation. Then the image, clip, video, etc. should be distributed to the participants in the incident group conversation instead of to all of the members of the group (which may include others not at the incident site).

Variously, the shared group manager server 20 provides an ability in broadband networks to dynamically manage group membership based on group-member-status. That is, the shared group manager server 20 introduces a dynamic/incident group membership based on the responders' group-member-status per-application. The group-member-status as a member of a group is based on a group member relationship with the group in a particular application, e.g., whether a member of a larger group is part of a subgroup G1 that is participating in an app1 14-1.

The shared group manager server 20 operates a process of supporting multiple types of group membership in a group based on group-member-status of group members in one or more of a set of applications. The process includes tracking a group-member-status of the group members in a first application (e.g., an app 14-1) of the set of applications, wherein the first application is operated with mobile devices of some or all of the group members, wherein the mobile devices communicate on a network, and wherein the group-member-status of each group member is based on the group member's relationship with the group in the first application. The process also includes receiving a request, from a second application (e.g., an app 14-2) of the set of applications, for a list of the group members having a particular status as a member of the group in the first application. The process further includes providing, to the second application, a list of the group members with the particular status in the first application.

For example, the group-member-status as a member of a group can have two components—a first component concerning whether the member is joined or not joined to the group in a specific application, and a second component concerning a priority of the group for the group member in the specific application. The group member can join a group in a specific application, e.g., a PTT call, but can also specify a certain priority of the group and/or application, e.g., whether the group is a primary group for this member with respect to participating in the application, e.g., a group call, or secondary group with respect to this group and application, e.g., for scanning the group call. The certain priorities can be, for example, 1 to N, where N>1. Other aspects of the group-member-status can also be considered in prioritizing the group and application, such as the type of device used, e.g., a handheld radio, a smart phone, a tablet, a vehicle modem, a desktop computer, etc. for users with multiple devices.

The group-member-status of the same member of the group can be different in different applications, e.g., the member may have joined the group in one application but may not have joined the group in another application. Also, in the same application the same member can have different group-member-status in different groups, e.g., the same responder may have joined one talk group but have not yet joined another talk group.

At any given time, the set of applications may include two general types of applications (and a given application may be of both categories at the same time), namely a first type of application that provides group-member-status updates to the shared group manager server 20, that is, an application having several group-member-statuses of each group member per group and reporting those statuses to the shared group manager server, and a second type of application that requests group-member-status updates from the shared group manager server, that is, an application requesting a group member and the status of a particular type (e.g., members joined at a certain priority, etc.) and/or requesting notification when a group-member-status changes for any group member. For example, the shared group manager server 20 can provide a status update of group-member-statuses of the group members in the first application (the app 14-1) to a third application (an app 14-3) of the set of applications.

In an exemplary embodiment, applications can request a list of group members based on their group-member-status as a member of the group in multiple applications simultaneously. For example, the process can include receiving, by the shared group manager server 20, a request for a list of the group members having a particular group-member-status as a member of the group in each of a first application and a second application, wherein the request is from a third application of the set of applications. The shared group manager server then can provide the list of the group members with the particular group-member-status to the third application. In another example, applications can request a list of group members having a particular group-member-status in the first application and having a different group-member-status in the second application.

In an exemplary embodiment, the network 10 can include an LTE network, the group members can be responders to an incident, and the set of applications can include any of video services, web services, push-to-talk services, location services, command-and-control services, and dispatch services, each of the services is a type of application. In another exemplary embodiment, the application app 14-1 can be a voice application, such as PTT, and the applications app 14-2 and app 14-3 can each be a data application, such as streaming video, etc.

The shared group manager server 20 tracks the applications' group-member-status for the group members and can add a list of special applications to the group definition. That is, the shared group manager server 20, for each group member, can track the group member's group-member-status as reported by the aforementioned applications, such as app 14-1, app 14-2, and app 14-3. When interacting with the shared group manager server 20, an application, such as app 14-3, can include one or more parameters in a group membership request that indicates, to the shared group manager server, which application(s), such as app 14-1 and app 14-2, and any particular attributes, such as group-member-status, of group members associated with each of app 14-1 and app 14-2, are of interest to the inquiring application app 14-3. The shared group manager server 20 then can provide to app 14-3 a subset of the group members that have the indicated, or selected, group member status in the indicated, or selected, application(s).

The shared group manager server 20 also can notify interested applications of changes of the group members' group-member-status in an indicated/selected application(s). Alternatively, the shared group manager server 20 can ask the selected application(s) for the current status of each group member and filter the membership list based on the selected group-member-status (and then provide the filtered list to a requesting application).

Thus, the various applications 14 can request and receive group member related information from the shared group manager server 20. The group member related information provided by the shared group manager server 20 includes group-member-status related to the applications 14, i.e., one application 14 can request the group-member-status of the group members in another application 14 for the group. The request to the shared group manager server 20 can identify not only the applications 14 and group or group member(s), but specific group-member-status attributes related to the applications 14. The applications 14 also can subscribe to the shared group manager server 20 for notification of group-member-status changes/updates. The shared group manager server 20 can request group-member-status information from the applications 14 to maintain up to date information. Thus, the shared group manager server 20 dynamically accounts for group member additions/deletions.

Advantageously, the shared group manager server 20 may provide different requesting applications 14 with different subsets of members of the same group, depending on which application(s) is indicated by the requesting application and on any particular group-member-status indicated, or selected, by the requesting application 14. This enables group-member-status to be exchanged between disparate applications 14 and enables an entire group or a subset of a group to be utilized by the application(s) 14, with each of the applications 14 having one or more defined groups/sub-groups.

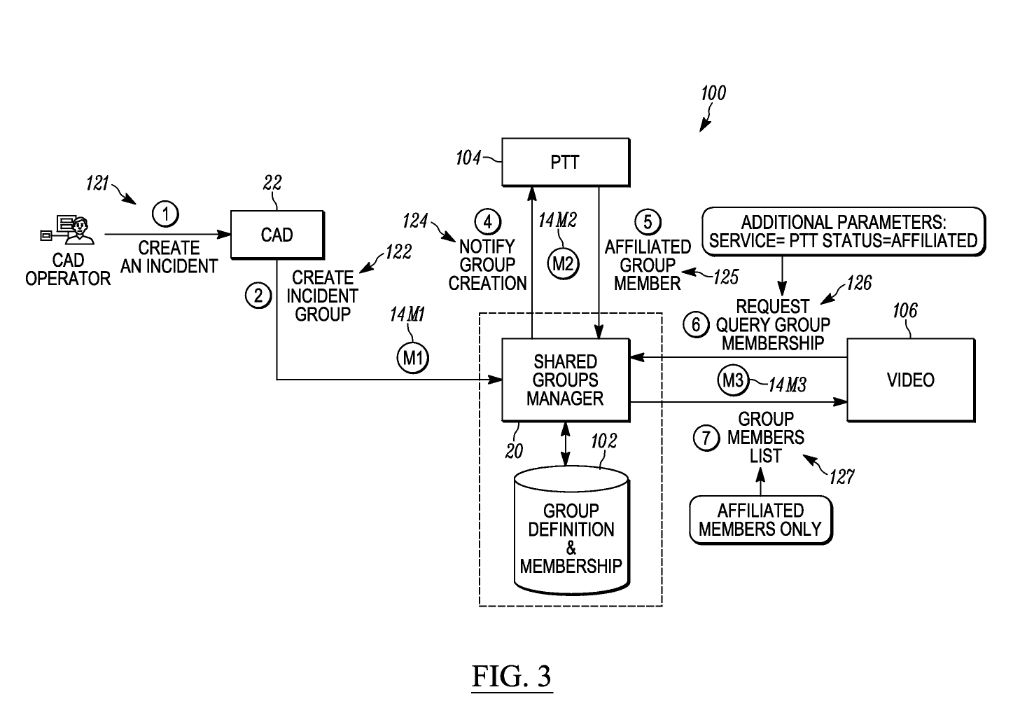

FIG. 3 is a network diagram of an exemplary network infrastructure 100 with the shared group manager server 20. The network infrastructure 100 illustrates a flow of an exemplary operation with the shared group manager server 20. In this example, three interfaces, 14M1, 14M2, 14M3 are depicted, that is, interfaces between the shared group manager server 20 and applications respectively residing on CAD 22 (i.e., interface 14M1), a PTT server 104 (i.e., interface 14M2), and a video server 106 (i.e., interface 14M3). The network infrastructure 100 further includes a group definition and membership database 102 communicatively coupled to the shared group manager 20. Note, various mobile devices 12 are omitted for illustration purposes in FIG. 3.

The exemplary operation includes a CAD operator creating an incident through the CAD 22 (step 121). The CAD 22 creates an incident group and further creates a corresponding incident group in the shared group manager server 20 via interface 14M1 (step 122). The shared group manager server 20 notifies the PTT server 104 of the incident group creation via interface 14M2 (step 124). Note, the steps 121, 122, and 124 include incident group creation flow where the PTT server 104 gets notified of the new group and informs the mobile devices 12 (not shown in FIG. 3).

When any of the mobile devices 12 join a PTT call, the PTT server 104 notifies the shared group manager server 20 of the group-member-status change for the group member that has joined the PTT call (step 125). Now suppose that while on the PTT call, there is a need by the video server 106 to distribute video or images to the users with the mobile devices 12 that are participating in the PTT call. The video server 106 connects to the shared group manager server 20 via the interface 14M3. In order to distribute video or images to the users with the mobile devices 12 participating in the PTT call, the video server 106 needs to identify those users/mobile devices. In order to identify such users/mobile devices, the video server 106 requests from, that is, queries, the shared group manager server 20 for a subset of the group members whose group-member-status in the PTT call is “joined.” That is, the video server 106 sends a group membership request or query to the shared group manager server 20 that includes parameters identifying the application or associated server of interest, that is, PTT, and the group-member-status of interest, that is, “joined” users (step 126). In other words, the video server 106 indicates to the shared group manager server that the video server is seeking to identify which of the group members are on the PTT call. The shared group manager server 20 then returns, to the requesting video server 106, a listing of group members (or a subset of group members if that there are other members of the group that are not participating in the PTT call), which listing comprises the group members who are joined to the PTT call (step 127).

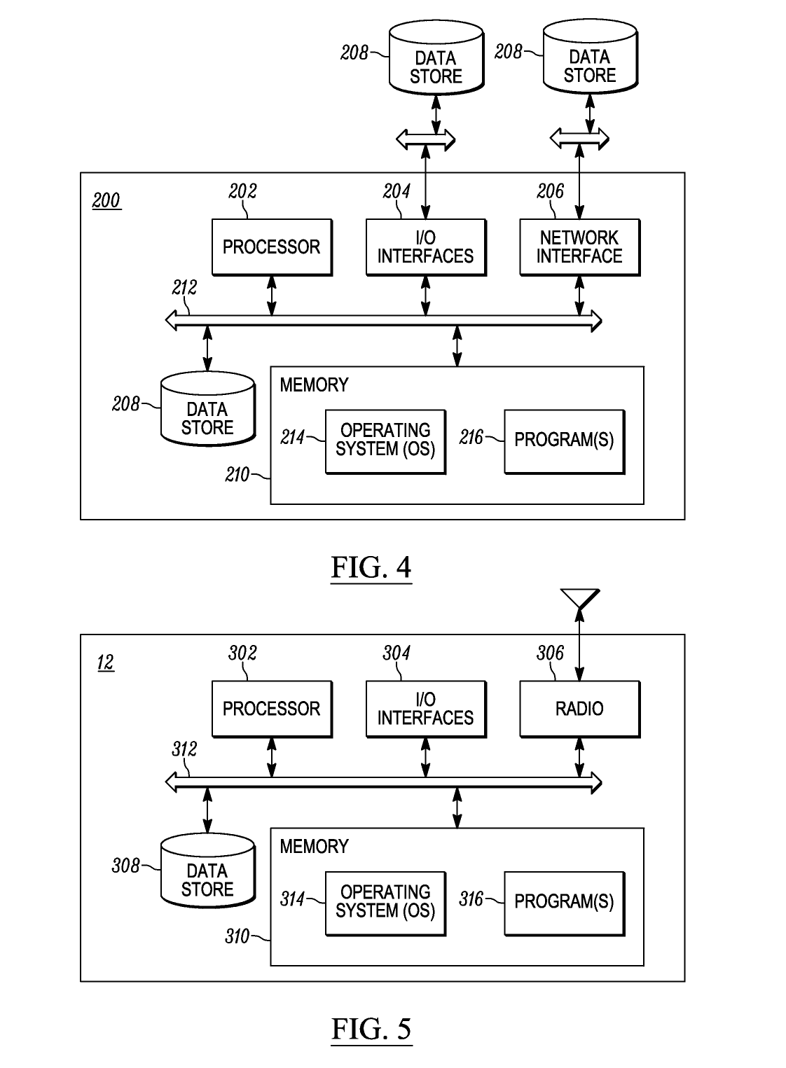

Referring now to FIG. 4, a block diagram is provided of a server 200 for implementing the shared group manager server 20. Specifically, the server 200 can implement the various processes described herein. The server 200 may be a digital computer that, in terms of hardware architecture, generally includes a processor 202, input/output (I/O) interfaces 204, a network interface 206, a data store 208, and a memory 210. It should be appreciated by those of ordinary skill in the art that FIG. 4 depicts the server 200 in an oversimplified manner, and a practical embodiment may include additional components and suitably configured processing logic to support known or conventional operating features that are not described in detail herein. The components 202, 204, 206, 208, and 210 are communicatively coupled via a local interface 212. The local interface 212 may be, for example but not limited to, one or more buses or other wired or wireless connections, as is known in the art. The local interface 212 may have additional elements, which are omitted for simplicity, such as controllers, buffers (caches), drivers, repeaters, and receivers, among many others, to enable communications. Further, the local interface 212 may include address, control, and/or data connections to enable appropriate communications among the aforementioned components.

The processor 202 is a hardware device for executing software instructions. The processor 202 may be any custom made or commercially available processor, a central processing unit (CPU), an auxiliary processor among several processors associated with the server 200, a semiconductor-based microprocessor (in the form of a microchip or chip set), or generally any device for executing software instructions. When the server 200 is in operation, the processor 202 is configured to execute software stored within the memory 210, to communicate data to and from the memory 210, and to generally control operations of the server 200 pursuant to the software instructions. The I/O interfaces 204 may be used to receive user input from and/or for providing system output to one or more devices or components. User input may be provided via, for example, a keyboard, touch pad, and/or a mouse. System output may be provided via a display device and a printer (not shown). I/O interfaces 204 may include, for example, a serial port, a parallel port, a small computer system interface (SCSI), a serial ATA (SATA), a fibre channel, Infiniband, iSCSI, a PCI Express interface (PCI-x), an infrared (IR) interface, a radio frequency (RF) interface, and/or a universal serial bus (USB) interface.

The network interface 206 may be used to enable the server 200 to communicate on a network, such as the Internet, a wide area network (WAN), a local area network (LAN), and the like, etc. The network interface 206 may include, for example, an Ethernet card or adapter (e.g., 10BaseT, Fast Ethernet, Gigabit Ethernet, 10 GbE) or a wireless local area network (WLAN) card or adapter (e.g., 802.11a/b/g/n). The network interface 206 may include address, control, and/or data connections to enable appropriate communications in the network 10. A data store 208 may be used to store data. The data store 208 may include any of volatile memory elements (e.g., random access memory (RAM, such as DRAM, SRAM, SDRAM, and the like), nonvolatile memory elements (e.g., ROM, hard drive, tape, CDROM, and the like), and combinations thereof. Moreover, the data store 208 may incorporate electronic, magnetic, optical, and/or other types of storage media. In one example, the data store 208 may be located internal to the server 200 such as, for example, an internal hard drive connected to the local interface 212 in the server 200. Additionally in another embodiment, the data store 208 may be located external to the server 200 such as, for example, an external hard drive connected to the I/O interfaces 204 (e.g., SCSI or USB connection). In a further embodiment, the data store 208 may be connected to the server 200 through a network, such as, for example, a network attached file server.

The memory 210 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 210 may incorporate electronic, magnetic, optical, and/or other types of storage media. Note that the memory 210 may have a distributed architecture, where various components are situated remotely from one another, but can be accessed by the processor 202. The software in memory 210 may include one or more software programs, each of which includes an ordered listing of executable instructions for implementing logical functions. The software in the memory 210 includes a suitable operating system (0/S) 214 and one or more programs 216. The operating system 214 essentially controls the execution of other computer programs, such as the one or more programs 216, and provides scheduling, input-output control, file and data management, memory management, and communication control and related services. The one or more programs 216 may be configured to implement the various processes, algorithms, methods, techniques, etc. described herein, including shared group server 20, the CAD 22, the PTT server 104, the video server 106 and the like.

The server 200 can include a program 216 of computer executable instructions which, in response to execution by the processor 202, cause the processor 292 to perform steps of: track a status of the group members in a first application of the set of applications, wherein the first application is operated with mobile devices of some or all of the group members and the mobile devices communicate on the network, and wherein the status is based on the group member relationship with the group in the first application; receive a request for the list of the group members with a particular status as a member of the group in the first application, wherein the request is from a second application of the set of applications; and provide a list of the group members with the particular status to the second application.

FIG. 5 is a block diagram of a mobile device 12, which may be used in the network 10 or the like, in accordance with some embodiments. For example, the mobile device 12 can include, without limitation, a smart phone, a radio, a tablet, a vehicle modem, etc. The mobile device 12 can be a digital device that, in terms of hardware architecture, generally includes a processor 302, input/output (I/O) interfaces 304, a radio 306, a data store 308, and a memory 310. It should be appreciated by those of ordinary skill in the art that FIG. 5 depicts the mobile device 12 in an oversimplified manner, and a practical embodiment may include additional components and suitably configured processing logic to support known or conventional operating features that are not described in detail herein. The components 302, 304, 306, 308, and 310 are communicatively coupled via a local interface 312. The local interface 312 can be, for example but not limited to, one or more buses or other wired or wireless connections, as is known in the art. The local interface 312 can have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 can be any custom made or commercially available processor, a central processing unit (CPU), an auxiliary processor among several processors associated with the mobile device 12, a semiconductor-based microprocessor (in the form of a microchip or chip set), or generally any device for executing software instructions. When the mobile device 12 is in operation, the processor 302 is configured to execute software stored within the memory 310, to communicate data to and from the memory 310, and to generally control operations of the mobile device 12 pursuant to the software instructions. In an exemplary embodiment, the processor 302 may include a mobile optimized processor such as optimized for power consumption and mobile applications. The I/O interfaces 304 can be used to receive user input from and/or for providing system output. User input can be provided via, for example, a keypad, a touch screen, a scroll ball, a scroll bar, buttons, bar code scanner, and the like. System output can be provided via a display device such as a liquid crystal display (LCD), touch screen, and the like. The I/O interfaces 304 can also include, for example, a serial port, a parallel port, a small computer system interface (SCSI), an infrared (IR) interface, a radio frequency (RF) interface, a universal serial bus (USB) interface, and the like. The I/O interfaces 304 can include a graphical user interface (GUI) that enables a user to interact with the mobile device 12.

The radio 306 enables wireless communication to an external access device or network. Any number of suitable wireless data communication protocols, techniques, or methodologies can be supported by the radio 306, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; Long Term Evolution (LTE); cellular/wireless/cordless telecommunication protocols (e.g. 3G/4G, etc.); Land Mobile Radio (LMR); Digital Mobile Radio (DMR); Terrestrial Trunked Radio (TETRA); Project 25 (P25); wireless home network communication protocols; paging network protocols; magnetic induction; satellite data communication protocols; wireless hospital or health care facility network protocols such as those operating in the WMTS bands; GPRS; proprietary wireless data communication protocols such as variants of Wireless USB; and any other protocols for wireless communication. The data store 308 may be used to store data. The data store 308 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media.

The memory 310 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 310 may incorporate electronic, magnetic, optical, and/or other types of storage media. Note that the memory 310 may have a distributed architecture, where various components are situated remotely from one another, but can be accessed by the processor 302. The software in memory 310 can include one or more software programs, each of which includes an ordered listing of executable instructions for implementing logical functions. In the example of FIG. 5, the software in the memory 310 includes a suitable operating system (O/S) 314 and programs 316. The operating system 314 essentially controls the execution of other computer programs, and provides scheduling, input-output control, file and data management, memory management, and communication control and related services. The programs 316 may include various applications, add-ons, etc. configured to provide end user functionality with the mobile device 12, including those mobile device functions set forth herein.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method of supporting multiple types of group membership in a group based on group-member-status as a member of a group in a set of applications, the method comprising:
tracking a group-member-status as a member of the group in a first application of the set of applications for each group member, wherein the first application is operated with mobile devices of some or all of the group members and the mobile devices communicate on a network, and wherein the group-member-status is based on a group member's relationship with the group in the first application;
receiving a request for a list of the group members with a particular group-member-status as a member of the group in the first application, wherein the request is from a second application of the set of applications; and
providing a list of the group members with the particular group-member-status in the first application to the second application.

2. The method of claim 1, further comprising:
notifying a third application of a change in the group-member-status of any group member based on the tracking.

3. The method of claim 2, wherein the second application and the third application comprise either a same or different application.

4. The method of claim 1, wherein the set of applications comprise two types of applications with:
a first type comprising applications having several group-member-statuses as a member of the group and reporting those group-member-statuses, and
a second type comprising applications requesting a group membership with group-member-status of a particular type and/or getting notified when a group-member-status changes for any group member.

5. The method of claim 1, further comprising:
providing the list of the group members with the particular group-member-status comprising the group members participating in the first application on the network, wherein the list comprising a subset of the group members.

6. The method of claim 1, wherein the network comprises a Long Term Evolution network, the group members comprise responders, and the set of applications comprise any of video services, web services, push-to-talk services, location services, command-and-control services, and dispatch services.

7. The method of claim 1, wherein the first application comprises a voice application and the second application comprises a data application.

8. The method of claim 1, further comprising:
receiving a request for the list of the group members with a particular group-member-status as a member of the group in the first application and as a member of a group in the second application, wherein the request is from a third application of the set of applications; and
providing a list of the group members with the particular group-member-status to the third application.

9. The method of claim 8, wherein the particular group-member-status in the first and the second applications are different.

10. A shared group manager server supporting multiple types of group membership in a group based on group-member-status as a member of a group in a set of applications, the shared group manager comprising:
a network interface communicatively coupled to a network;
a processor communicatively coupled to the network interface; and
memory storing computer executable instructions, and in response to execution by the processor, the computer executable instructions cause the processor to perform steps of:
track a group-member-status as a member of the group in a first application of the set of applications for each group member, wherein the first application is operated with mobile devices of some or all of the group members and the mobile devices communicate on the network, and wherein the group-member-status is based on a group member's relationship with the group in the first application;
receive a request for a list of the group members with a particular status as a member of the group in the first application, wherein the request is from a second application of the set of applications; and
provide a list of the group members with the particular group-member-status in the first application to the second application.

11. The shared group manager server of claim 10, wherein the computer executable instructions further cause the processor to perform steps of:
notify the second application or a third application of a change in the group-member-status of any group member based on tracking.

12. The shared group manager server of claim 11, wherein the second application and the third application comprise either a same or different application.

13. The shared group manager server of claim 10, wherein the set of applications comprise two types of applications with:
a first type comprising applications having several group-member-statuses as a member of the group and reporting those statuses, and
a second type comprising applications requesting a group membership and group-member-status of a particular type and/or getting notified when a status change for any group member.

14. The shared group manager server of claim 10, wherein the computer executable instructions further cause the processor to perform steps of:
provide a status update of the group-member-status of the group members in the first application to a third application of the set of applications.

15. The shared group manager server of claim 10, wherein the computer executable instructions further cause the processor to perform steps of:
provide the list of the group members with the particular group-member-status comprising the group members participating in the first application on the network, wherein the list comprising a subset of the group members.

16. The shared group manager server of claim 10, wherein the network comprises a Long Term Evolution network, the group members comprise responders, and the set of applications comprise any of video services, web services, push-to-talk services, location services, command-and-control services, and dispatch services.

17. The shared group manager server of claim 10, wherein the first application comprises a voice application and the second application comprises a data application.

18. A network, comprising:
a plurality of mobile devices communicatively coupled to one another wirelessly and each operating a plurality of applications; and
a shared group manager server communicatively coupled to the plurality of mobile devices, wherein the shared group manager comprises memory storing computer executable instructions, and in response to execution by a processor, the computer executable instructions cause the processor to:
track a group-member-status as a member of a group in a first application of the plurality of applications for each group member, wherein the group-member-status is based on a group member's relationship with the group in the first application;
receive a request for the group-member-status of the group members in the first application identifying the group members with a particular group-member-status, wherein the request is from a second application of the plurality of applications; and
provide a list of the group members with the particular group-member-status in the first application to the second application.

19. The network of claim 18, wherein a mobile device of the plurality of mobile devices comprises memory storing computer executable instructions, and in response to execution by a processor, the computer executable instructions cause the processor to perform steps of:
request the group-member-status of any group member in the first application identifying the group members with a particular group-member-status by the second application or a third application on the mobile device.

20. The network of claim 18, wherein the network comprises a Long Term Evolution network, the group members comprise responders, and the applications comprise any of video services, web services, push-to-talk services, location services, command-and-control services, and dispatch services.
